(19) United States
(12) Patent Application Publication
(10) Pub. No.: US 2024/0362533 A1
(43) Pub. Date: Oct. 31, 2024

(54) METHODS, SYSTEMS, ARTICLES OF MANUFACTURE AND APPARATUS TO REDUCE LONG-TAIL CATEGORIZATION BIAS

(71) Applicant: Nielsen Consumer LLC, Chicago, IL (US)

(72) Inventors: Diego Ortego Hernández, Alcobendas (ES); David Jiménez Cabello, Lupiana (ES)

(21) Appl. No.: 18/309,325

(22) Filed: Apr. 28, 2023

(51) Int. Cl. G06N 20/00

(52) U.S. Cl. CPC G06N 20/00

(57) ABSTRACT

Methods, apparatus, systems, and articles of manufacture are disclosed to train machine learning models to reduce categorization bias, the apparatus comprising: interface circuitry; machine readable instructions; and programmable circuitry to at least one of instantiate or execute the machine readable instructions to: calculate category information corresponding to samples based on a plurality of models; calculate task loss values associated with respective ones of the samples and respective ones of the plurality of models based on product category information; calculate gating loss values for a model gate based on category frequency information; and train the model gate based on a sum of the task loss and the gating loss, the training to derive weights corresponding to respective ones of the plurality of models.

### FIELD OF THE DISCLOSURE

This disclosure relates generally to predicting categories and, more particularly, to methods, systems, articles of manufacture and apparatus to reduce long-tail categorization bias.

### BACKGROUND

In recent years, product categorization from textual descriptions has become a fundamental step of obtaining sales information. Machine learning models have allowed for the automation of data categorization methods, in which the collected data is assigned a category based on textual information.

### BRIEF DESCRIPTION OF THE DRAWINGS

FIG. 1 is a block diagram of an example environment in which example prediction circuitry operates to predict expert weights structured in accordance with teachings of this disclosure.

FIG. 2 is a block diagram of an example implementation of the prediction circuitry of FIG. 1 structured in accordance with the teachings of this disclosure.

FIG. 3 is a flowchart representative of example machine readable instructions and/or example operations that may be executed, instantiated, and/or performed by example programmable circuitry to implement the prediction circuitry of FIG. 2.

FIG. 4 is a schematic diagram of an example implementation of the prediction circuitry of FIG. 2.

FIG. 5 is a block diagram of an example processing platform including programmable circuitry structured to execute, instantiate, and/or perform the example machine readable instructions and/or perform the example operations of FIG. 3 to implement the prediction circuitry of FIG. 2.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

In artificial intelligence systems, automated model training for machine learning models is a valuable asset. One aspect of machine learning models is training models to predict product categorization from textual descriptions, such as receipts. Machine learning models provide the ability interpret textual data collected from various sources and determine categories and/or classes the data belongs to. For example, a textual description “coke 330 mL” belongs to a category “soft drinks.” In some examples, the category the textual description belongs to is referred to as category information. In some instances, this data is highly imbalanced in terms of the number of samples (e.g., the number of data points) in each of the categories and/or classes of interest (e.g., few categories and/or classes are more common and gather a vast number of data points, while most categories and/or classes appear less often with relatively fewer data points therein). These large number of categories and/or classes, with few samples are referred to as long-tail distribution of the data.

Machine learning models learn by repetition and when samples from certain categories and/or classes are repeated, the models learn a bias towards predicting such categories and/or classes. Examples disclosed herein mitigate these bias problems to provide reliable models that exhibit less bias and/or error. The data set is fed to the machine learning models in batches. The batches are small subsets of the data set fed to the model. In some cases, machine learning models are fed a data set that is distributed into three characterizations and/or typology: head, body, and tail. Typology, as used herein, is a classification according to a type of category and/or class. In some examples, the data set is distributed based on category frequency. As used herein, the head (e.g., a first category frequency) represents a few classes that meets a first threshold quantity of the samples and/or datapoints, the body (e.g., a second category frequency) represents classes that meets a second threshold of samples and/or data points that is less than the first threshold quantity, and the tail (e.g., a third category frequency) represents many classes with a third threshold quantity of samples and/or data points that is less than the second threshold quantity. Stated differently, a head class is a type of class that represents a greater number of samples and/or data points when compared to a body class or a tail class. For example, categories and/or classes with samples and/or data points that represent more than 50% of the data points within the data set represent the head, while the body and tail correspond to categories and/or classes representing 40% and 10% of the data points within the data set respectively. In this example, the first threshold quantity is 50% of the samples and/or data points, the second threshold quantity is 40% of the samples and/or data points, and the third threshold quantity is 10% of the samples and/or data points.

One example of a data set is liquor store inventory distributed into three characterizations and/or typology: head, body, and tail. In this example, all the products sold at a liquor store are included within the data set. Here, product categories that meet the first threshold quantity are beer, wine, and liquor because these categories are the most frequently sold products at the liquor store, and thus beer, wine, and liquor belong to the head characterization and/or typology. Products categories such as bottle openers, reusable cups, and flasks that meet the second threshold quantity belong to the body characterization and/or typology because they are sold often but not as frequently as the head characterization and/or typology. Product categories that are less than a third threshold, such as, magnets and snacks belong to the tail characterization because they are sold relatively infrequently as compared to the head and/or body. In some examples, correctly categorizing textual descriptions (e.g., receipts, e-commerce, etc.) allows liquor store retailers to properly stock their store shelves and store inventory based on the frequency of sales for each category.

In some examples, a label frequency refers to the number of samples and/or datapoints in a particular category and/or class divided by the total number of samples and/or data points in the data set. Examples disclosed herein address the long-tail problem by learning several expert systems, such as, experts specialized for different ranges of classes (e.g., tail, body and head of a data set); and dynamically combining these experts for each sample, so that a robust prediction is provided. As used herein, an expert is analogous to a model. To reduce bias towards predicting classes of data that are repeated most often, examples disclosed herein invoke a combination strategy, which is performed using a multilayer perceptron (MLP) gate (e.g., a model gate) that can identify the best combination of experts possible for each sample instead of using the same combination for all samples, described in further detail below.

In traditional methods, a problem persists when trying to mitigate the head bias. Current methods decrease the performance on head classes by decreasing the influence a head expert (described in further detail below) has on a sample and/or data point prediction. However, head classes include the most repeated samples and/or data points. Thus, decreasing the influence of the head expert for samples and/or data points that fall within head classes decreases the performance of correctly categorizing them. Stated differently, these traditional approaches introduce error in the attempt to dampen and/or otherwise attenuate an over-dominant influence of the head class data. Again, head classes represent the largest quantity of samples and/or data points, therefore, decreasing the performance of correctly categorizing them negatively impacts coverage. As used herein, the coverage is defined as a percentage of samples that a model can categorize meeting a certain performance requirement. For example, a coverage of 80% at a 95% accuracy means that the model is classifying 80% of the samples with at least 95% of accuracy. This is determined by setting a threshold that discards the 20% remaining data because those predictions have relatively lower performance. As used herein, high coverage represents models that satisfy a threshold percentage of categorized samples and/or data points at a threshold accuracy and low coverage represents models that do not satisfy the threshold percentage of categorized samples and/or data points at a threshold accuracy. In some examples, the threshold percentage of interest is equal to 90%, but examples disclosed herein are not limited thereto.

Additionally, in current (e.g., traditional) methods low confidence predictions are often rejected and revised by human analysis. Low confidence predictions are discarded predictions that condition the coverage. For example, 1% of low confidence predictions in a batch (e.g., predictions that do not exceed the threshold set to meet the desired accuracy of 95% accuracy) and with that 1% of discarded predictions the coverage would be 99%. Low coverage implies more human intervention to revise the models' predictions, which takes time and is prone to errors (e.g., human discretionary error). Given the long-tailed nature of the data, head classes appear more often and predicting them accurately is key to assure high coverage. Unfortunately, current methods dealing with data imbalance often decrease the performance in the head classes when trying to work well across all existing classes, when presented with a standard training bias towards the head. This situation hinders the application in real environments of long-tail robust training strategies. To address this problem and bridge the gap between research and production environments, examples disclosed herein improve the results in the tail, while maintaining accurate performance (e.g., preventing bias) in the head with respect to standard training strategies. Consequently, examples disclosed herein are robust for production environments and work better across all characterizations and/or typologies producing less biased models and reducing the need for human intervention.

As described above, traditional approaches decreased the head expert bias by decreasing the influence of the head expert across all sample and/or data point types. As a result, traditional approaches decreased the coverage, and thus required re-calculation efforts with processors and/or human intervention, which are energy intensive processes. In some examples, calculations are performed on large volumes of data that are beyond the capabilities of human processing. In some examples, these large volumes of data are processed by server farms and/or cloud computing resources that consume a particular amount of energy during such processing activities. Examples disclosed herein facilitate energy savings because the training bias towards the head classes is removed without decreasing coverage by considering the characterization and/or typology of each sample and/or data point and weighing expert influence accordingly. Consequently, examples disclosed herein do not require re-calculation efforts (e.g., a reduction in calculation time consumption and calculation energy consumption) and remove the need for human intervention. Accordingly, the examples disclosed herein train models faster because re-calculation efforts are no longer required and are less prone to human errors because human intervention is no longer needed.

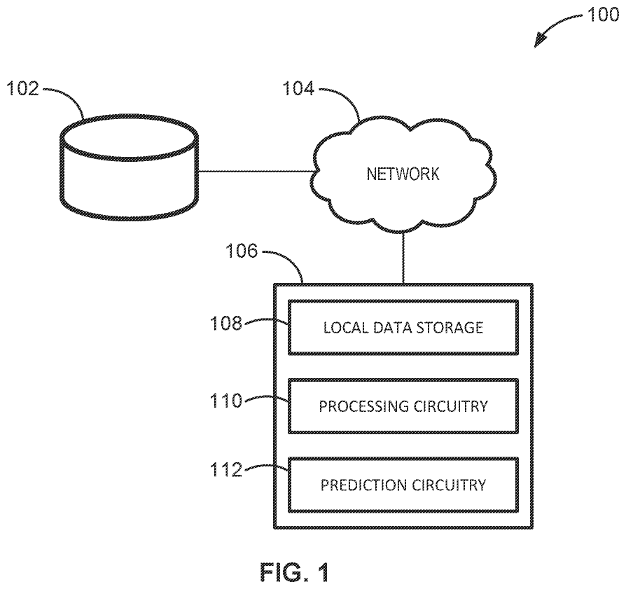

FIG. 1 is a block diagram of an example environment 100 in which example prediction circuitry 112 operates to predict categories corresponding to textual descriptions in accordance with teachings of this disclosure. Categories, as used herein, represent a class of samples (e.g., individual ones of items, such as, products) belonging to the same group (e.g., soft drinks, beauty products, cleaning products, etc.). For example, in a data set of samples including textual descriptions “sprite,” “mountain dew,” and “Dr. Pepper,” the textual descriptions belong to the category soft drinks. Batches, as used herein, represent retrieved data broken into groups that are fed to a machine learning model one after another. Stated differently, batches represent a relatively smaller portion or group of a data set that is provided to a machine learning model. In some examples, the relatively smaller batches are used to accommodate for limited processor capabilities and/or bandwidth data limitations in a communication network. In some examples, batches are provided in a serial manner to allow processing equipment to process a first received batch before attempting to process a subsequent batch, thereby reducing a likelihood of inundating the processing resource(s). Thus, the machine learning model processes a first batch, learns information based on the first batch and updates the model to behave better for an incoming second batch. In the illustrated example of FIG. 1, the environment 100 includes an example database 102, an example network 104, an example processor platform(s) 106, example processing circuitry 110, and example prediction circuitry 112.

As described above, the example environment 100 addresses problems related to wasteful human resources associated with model training. Generally speaking, existing approaches train machine learning models by repetition and when samples from certain classes are repeated, the model learns a bias (e.g., head bias) towards predicting such classes. Typical approaches attempt to mitigate the head bias also decrease the prediction performance on head classes. In some examples, batches may include data stored in the example database 102. In some examples, local data storage 108 is stored on the processor platform(s) 106. While the illustrated example of FIG. 1 shows the database 102, examples disclosed herein are not limited thereto. For instance, any number and/or type of data storage may be implemented that is communicatively connected to any number and/or type of processor platform(s) 106, either directly and/or via the example network 104.

As described in further detail below, the example environment 100 to predict categories for textual descriptions (and/or circuitry therein) acquires and/or retrieves labeled and/or described data to build batches from retrieved data to feed machine learning models for training. The example processor platform(s) 106 instantiates an executable that relies upon and/or otherwise utilizes one or more models in an effort to complete an objective, such as translating product descriptions from samples. In operation, the example prediction circuitry 112 constructs batches of retrieved data containing information (e.g., product descriptions, characterization, etc.), which trains machine learning models to predict categories for textual descriptions (e.g., Doritos belongs to a snack category, Tropicana belongs to a juice category, etc.). In some examples, textual descriptions are derived from receipts generated by retailers. In some examples, textual descriptions are derived from e-commerce. In some examples, data is inferred to belong to characterizations (e.g., head, body, and tail) using given category annotation from annotators. For example, because it is known that the soft drink category appears many times, it can be inferred that the soft drink category is a head characterization (e.g., the characterization is computed automatically from data point category annotations). The data includes any number of samples from retrieved data, described in further detail below. The batches include samples and/or data characterization (e.g., head class, body class, and/or tail class) which are particular sample characterization or sample groupings inferred as one of these data types so that model training efforts include specificity.

When preparing to train machine learning models to predict categories of textual description, data is retrieved by the prediction circuitry 112 and it filters the data into batches (e.g., small groups) to be fed to the machine learning model. For example, if 1000 samples were included in the retrieved data, the prediction circuitry 112 may distribute the 1000 samples into ten batches including 100 samples in each batch. As mentioned previously, the retrieved data is visualized in batches (e.g., small groups) that are fed one after another to the model. Thus, the model sees a batch (e.g., small group) one at a time and based on information learned the model is updated to behave better (e.g., predict categories accurately) for the next batch (e.g., small group). The prediction circuitry 112 calculates a prediction (e.g., category information) for each sample in a first batch using a first expert, a second expert, a third expert. For example, assuming each batch contains 100 samples, as in the example above, then the prediction circuitry 112 will provide 100 predictions (e.g., category information) using each expert. Thus, in this example, the prediction circuitry 112 will predict 300 predictions, a prediction generated from each expert for each sample within the batch. In some examples, the first expert, the second expert, and the third expert correspond to a head expert, a body expert, and a tail expert, respectively. The head expert, body expert, and tail expert are trained to be specialized, respectively, on the head classes, the body classes, and the tail classes. As a result, the head expert predicts samples and/or data points from head classes with greater accuracy than samples and/or data points from the body classes and the tail classes. Stated differently, if the head expert is fed a sample and/or data point from a tail class, the result may be inaccurate. However, the examples herein shall not be limited to three experts. In some examples, the prediction circuitry 112 calculates a loss for each sample in the first batch using the first expert and/or the second expert. In examples disclosed herein, the prediction circuitry 112 uses three experts, however, in other examples, the prediction circuitry 112 calculates a loss for each sample in the first batch using more than three experts.

In some examples, the first expert (e.g., head expert) calculates a loss using an example softmax cross-entropy loss technique in a manner consistent with example Equation 1.

$${L}_{ce} = \frac{1}{{n}_{s}} {\sum }_{{x}_{i} ∈ {D}_{s}} - ( y ) log σ ( {v}_{1} ( {x}_{i} ) ) \qquad Equation 1$$

At least one objective of the example softmax cross-entropy loss function of Equation 1 is to reduce (e.g., minimize) the loss value, L_{ce}. The lower the loss, L_{ce}, the better the model performs when predicting samples and/or data points categories and/or classes. At least one purpose of example Equation 1 (sometimes referred to herein as a logarithmic loss equation) is to reduce (e.g., minimize) the loss, the smaller the loss the better the model performs (e.g., a perfect model has a L_{ce} of zero). In the illustrated example of Equation 1, Ds={xi, yi}ᵢ₌₁^{ns} denotes a long-tailed training dataset, where y is a class and/or category label of a sample xi. The total number of training samples and/or data points over “C” quantity of classes and/or categories is nₛ. Further, v₁ represents the output logits of the head expert, and σ is the softmax function.

In some examples, the second expert (e.g., body expert) calculates the loss using a balanced softmax loss technique in a manner consistent with example Equation 2.

$${L}_{bal} = \frac{1}{{n}_{s}} {\sum }_{{x}_{i} ∈ {D}_{s}} - ( {y}_{i} ) log σ ( {v}_{2} ( {x}_{i} ) + log π ) \qquad Equation 2$$

At least one objective of the example balanced softmax loss function of Equation 2 is to reduce (e.g., minimize) the loss value, L_{bal}. The lower the loss, L_{bal}, the better the model performs when predicting samples and/or data points categories and/or classes. At least one purpose of example Equation 2 (sometimes referred to herein as another logarithmic loss equation) is to reduce (e.g., minimize) the loss, the smaller the loss the better the model performs (e.g., a perfect model has a L_{bal} of zero). In the illustrated example of Equation 2, Ds={xi, yi}ᵢ₌₁^{ns} denotes a long-tailed training dataset, where y is a class and/or category label of a sample xi. The total number of training samples and/or data points over “C” quantity of classes and/or categories is nₛ. Further, v₂ represents the output logits of the body expert, π represents the frequencies of the classes, and σ is the softmax function. For example, if there are 10 classes, x is a vector of 10 elements, each being the frequency of a particular class. In Equation 2, log(x) is the term added that forces the balanced behavior.

In some examples, the third expert (e.g., tail expert) calculates the loss using an inverted softmax loss technique in a manner consistent with example Equation 3.

$${L}_{inv} = \frac{1}{{n}_{s}} {\sum }_{{x}_{i} ∈ {D}_{s}} - ( {y}_{i} ) log σ ( {v}_{3} ( {x}_{i} ) + log π - λ log \overline{π} ) \qquad Equation 3$$

At least one objective of the example inverted softmax loss function of Equation 3 is to reduce (e.g., minimize) the loss value, Lᵢₙᵥ. The lower the loss, Lᵢₙᵥ, the better the model performs when predicting samples and/or data points categories and/or classes. At least one purpose of example Equation 3 (sometimes referred to herein as another logarithmic loss equation) is to reduce (e.g., minimize) the loss, the smaller the loss the better the model performs (e.g., a perfect model has a Lᵢₙᵥ of zero). In the illustrated example of Equation 3, Ds={xi, yi}ᵢ₋₁^{ns} denotes a long-tailed training dataset, where y is a class and/or category label of a sample xi. The total number of training samples and/or data points over “C” quantity of classes and/or categories is nₛ. Further, v₃ represents the output logits of the tail expert, x represents the frequencies of the classes, and σ is the softmax function. In Equation 3, the correction is done with log(π)−λ*log(π̅) instead of using log(π) as in Equation 2. λ represents a hyperparameter that controls the strength of the inverted correction. In some examples, λ is equal to 1.

Equations 1, 2 and 3 are used in a first stage to train expert 1, expert 2, and expert 3, respectively, and then the experts are frozen for the second training stage. In this second training, the prediction circuitry 112 calculates a weight for each expert using a multilayer perception (MLP) gate. For example, if particular sample is a textual description “sprite” and it is determined that the sample “sprite” is a head characterization and/or typology, the prediction circuitry 112 may calculate the following weights: 99% head expert, 0.5% body expert, and 0.5% tail expert. This forces the machine learning model to predict a fitting expert selection and a product categorization prediction based on each sample's characteristics and/or typology (e.g., head, body, or tail) rather than a fixed combination of expert predictions for all samples. Previous methods used a fixed combination of expert prediction which weighted the head expert less to remove head bias. However, this reduced the model accuracy (e.g., coverage) and often required human intervention. This ability to use a dynamic expert selection based on sample characteristics and/or typology (e.g., head, body, or tail), removes bias towards the head classes without decreasing coverage because it considers the characterization and/or typology of each sample and/or data point and weighs expert influence accordingly. As a result, models train faster, models improve accuracy (e.g., coverage), consume fewer resources, and consequently, save energy.

The prediction circuitry 112 trains the MLP gate using a first loss and a second loss. The MLP gate (e.g., model gate) determines the contribution of each expert (e.g., the first expert, the second expert, and the third expert) for each sample and/or data point. In some examples, the MLP gate (e.g., model gate) determines the contribution of the first expert, the second expert, and the third expert and outputs a first weight, a second weight, a third weight to determine the contribution of each expert. The prediction circuitry 112 trains the MLP gate (e.g., model gate) via a task loss (e.g., the first loss), which optimizes the model to predict the correct characterization the sample belongs to. This prediction of the MLP gate (e.g., model gate) is used to combine the predictions of the first expert, the second expert, and the third expert to optimize the model so that that combined prediction produces the correct category for each sample. In some examples, the task loss value is determined using the softmax cross-entropy loss. The task loss is a function that depends on a product category ground truth indicator and/or or product category information, such as, soft drink. For example, if a product such as Sprite (e.g., sample and/or data point) is within the data, the data would also include that Sprite belongs to a category soft drink (e.g., the product category ground truth indicator). This loss is important to make sure that the MLP gate (e.g., model gate) is optimized to perform well on product categorization. In some examples, the task loss value is calculated by using the example softmax cross-entropy loss technique shown above (e.g., see Equation 1), with the product ground truth indicator data to determine whether a combined prediction matches the product category ground-truth indicator. As used herein, the combined prediction is the weighted average of the predictions (e.g., category information) provided by each expert wherein the weights are provided by the MLP gate (e.g., model gate). The example prediction circuitry 112 then defines what threshold of samples in a class constitute the head, body, and tail. In some examples, classes that meet the first threshold quantity represent the head, while the body and tail correspond to classes meeting the second threshold and the third threshold, respectively. The MLP gate (e.g., model gate) learns how to predict the characterization and in a production environment the MLP gate (e.g., model gate) can predict and use a combination of experts that relies on the expert that corresponds to the characterization. In some examples, classes with samples that gather more than 60% of the data within the data set represent the head, while the body and tail correspond to classes gathering 25% and 15% of the data within the data set, respectively.

The prediction circuitry 112 then builds an expert selection ground truth indicator denoting the relevant expert to be predicted for each sample by determining for each sample a characterization and/or typology (e.g., head, body, or tail). The prediction circuitry 112 then calculates a gating loss using the expert selection ground truth indicator (e.g., if sample belongs to the head characterization and/or typology then the expert selection should be the head expert). In some examples, the gating loss is determined using the softmax cross-entropy loss. The gating loss is a function that depends on the expert selection ground truth indicator, such as, head class. For example, during training a product (e.g., sample and/or data point) would also include data indicating which a characterization and/or typology (e.g., head, body, or tail) the product belongs to. This loss is important to make sure that the MLP gate (e.g., model gate) is optimized to predict the right expert to be selected. In some examples, the gating loss is calculated by using the example softmax cross-entropy loss techniques in a manner consistent with example Equation 1 above, with the expert selection ground truth indicator to ensure that the correct expert is selected. The prediction circuitry 112 then trains the MLP gate (e.g., model gate) by summing the task loss and the gating loss multiplied by a multiplication factor. In some examples, the multiplication factor is equal to 0.01. The gating loss is multiplied by the multiplication factor to modulate the contribution of the gating loss. In some examples, the task loss is multiplied by a multiplication factor. In this example, the gating loss is introduced with a lower contribution than the task loss so that the joint optimization (e.g., the task loss and gating loss combined) produces weights that not only lead to correctly predicting product categorization, but also identify the correct expert for each sample. In some examples, this is consistent with example Equation 4 shown below:

$$Training MLP gate = task loss + ( gating loss ) \times 0.01 \qquad Equation 4$$

The prediction circuitry 112 trains this MLP gate (e.g., model gate) to produce weights that are accurate at identifying if a sample comes from the head, body or tail using the gating loss. This means that when a sample is from the tail, the MLP gate (e.g., model gate) optimizes to get a relatively high value for the tail (e.g., 0.1 (head), 0.1 (body), 0.8 (tail)). However, the MLP gate (e.g., model gate) is trained to produce 0 (head), 0 (body), 1 (tail). Further, the MLP gate (e.g., model gate) combines the experts and produces an accurate prediction for product categorization. In some examples, correctly predicting the categorization of samples and/or data points saves retailers and/or vendors from over stocking or under stocking products. For example, based on receipts the MLP gate (e.g., model gate) can correctly predict which category the products on the receipt belong to. Using this information, retailers and/or vendors are able to order goods based on categories of products that are frequently sold and order less of categories that are infrequently sold. In consequence, retailers and/or vendors are able to save energy by reducing shipments of products that are not sold as frequently. Furthermore, retailers and/or vendors are able to increase business by stocking shelves with products that tend to sell more often. Additionally, by correctly predicting product categorization, retailers and/or vendors reduce waste by storing less products that infrequently sell and therefore are discarded (e.g., expiration date pass). Thus, the MLP gate (e.g., model gate) reduces energy consumption by creating less waste due to a surplus of products that are trending to sell infrequently.

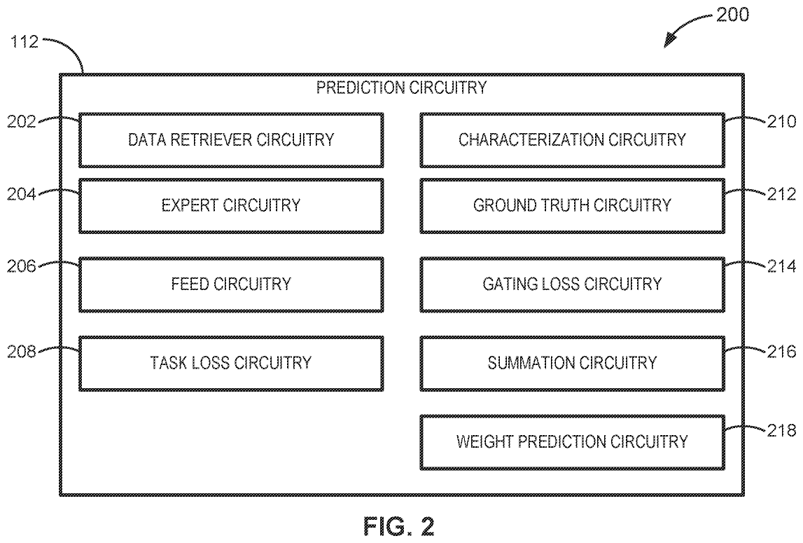

FIG. 2 is a block diagram of an example implementation of the prediction circuitry 112 of FIG. 1 to predict categories for textual descriptions. The prediction circuitry 112 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the prediction circuitry 112 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

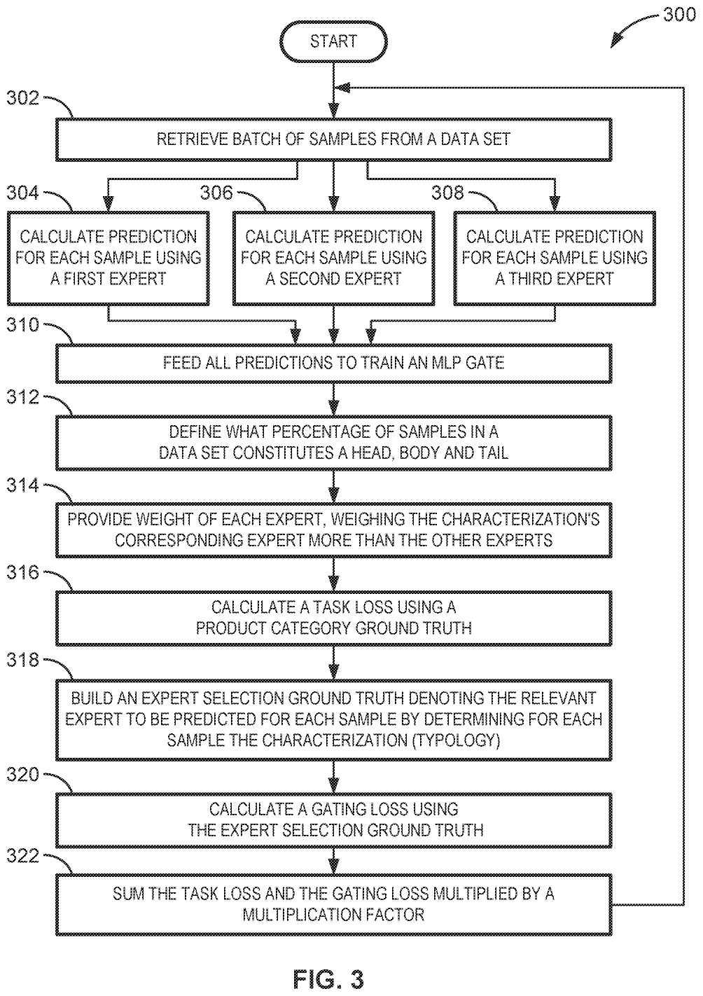

The prediction circuitry 112 includes data retriever circuitry 202, which retrieves a data set from the database 102 and/or local data storage 108 and further retrieves a batch of samples from the data set. The database 102 may be implemented as any type of storage device (e.g., cloud storage, local storage, or network storage). In some examples, the data retriever circuitry 202 is instantiated by programmable circuitry executing data retriever instructions and/or configured to perform operations such as those represented by the flowchart(s) of FIG. 3.

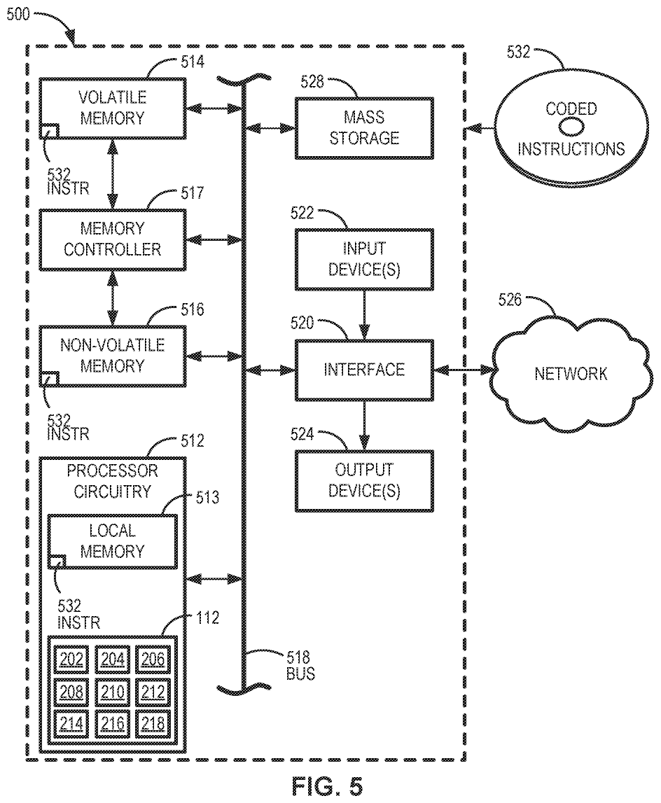

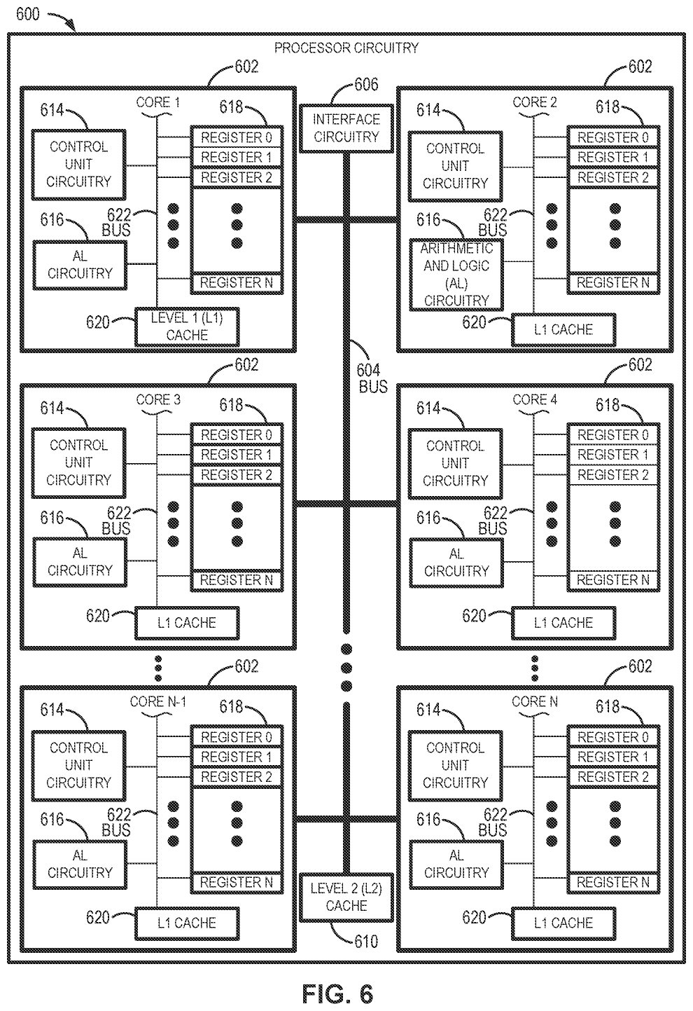

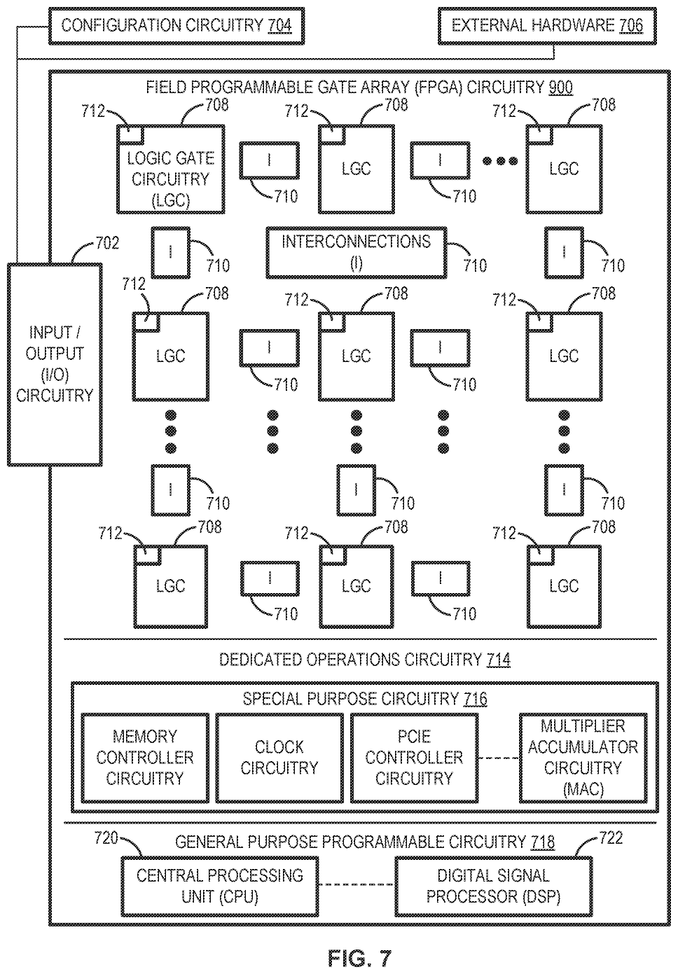

In some examples, the apparatus includes means for retrieving data. For example, the means for retrieving may be implemented by data retriever circuitry 202. In some examples, the data retriever circuitry 202 may be instantiated by programmable circuitry such as the example programmable circuitry 512 of FIG. 5. For instance, the data retriever circuitry 202 may be instantiated by the example microprocessor 600 of FIG. 6 executing machine executable instructions such as those implemented by at least blocks 302 of FIG. 3. In some examples, data retriever circuitry 202 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the data retriever circuitry 202 may be instantiated by any other combination of hardware, software, and/or firmware. For example, the data retriever circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Additionally, the example prediction circuitry 112 includes expert circuitry 204, which calculates and/or evaluates a prediction using all available experts of interest (e.g., the first expert, the second expert, and the third expert) for each sample in the batch. In some examples, the expert circuitry 204 is instantiated by programmable circuitry executing expert instructions and/or configured to perform operations such as those represented by the flowchart(s) of FIG. 3.

In some examples, the apparatus includes means for retrieving data. For example, the means for calculating may be implemented by expert circuitry 204. In some examples, the expert circuitry 204 may be instantiated by programmable circuitry such as the example programmable circuitry 512 of FIG. 5. For instance, the expert circuitry 204 may be instantiated by the example microprocessor 600 of FIG. 6 executing machine executable instructions such as those implemented by at least blocks 304, 306, 308 of FIG. 3. In some examples, expert circuitry 204 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the expert circuitry 204 may be instantiated by any other combination of hardware, software, and/or firmware. For example, the expert circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The prediction circuitry 112 includes feed circuitry 206, which feeds the predictions to an MLP gate (e.g., model gate) for training. In some examples, the feed circuitry 206 is instantiated by programmable circuitry executing feed instructions and/or configured to perform operations such as those represented by the flowchart(s) of FIG. 3.

In some examples, the apparatus includes means for retrieving data. For example, the means for feeding may be implemented by feed circuitry 206. In some examples, the feed circuitry 206 may be instantiated by programmable circuitry such as the example programmable circuitry 512 of FIG. 5. For instance, the feed circuitry 206 may be instantiated by the example microprocessor 600 of FIG. 6 executing machine executable instructions such as those implemented by at least blocks 310 of FIG. 3. In some examples, feed circuitry 206 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the feed circuitry 206 may be instantiated by any other combination of hardware, software, and/or firmware. For example, the feed circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The prediction circuitry 112 includes task loss circuitry 208, which calculates and/or determines a task loss value using a product category ground truth indicator. In some examples, the task loss circuitry 208 is instantiated by programmable circuitry executing task loss instructions and/or configured to perform operations such as those represented by the flowchart(s) of FIG. 3.

In some examples, the apparatus includes means for retrieving data. For example, the means for calculating may be implemented by the task loss circuitry 208. In some examples, the task loss circuitry 208 may be instantiated by programmable circuitry such as the example programmable circuitry 512 of FIG. 5. For instance, the task loss circuitry 208 may be instantiated by the example microprocessor 600 of FIG. 6 executing machine executable instructions such as those implemented by at least blocks 316 of FIG. 3. In some examples, the task loss circuitry 208 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the task loss circuitry 208 may be instantiated by any other combination of hardware, software, and/or firmware. For example, the task loss circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The prediction circuitry 112 includes characterization circuitry 210, which defines what percentage of samples in a data set constitutes a head, body, and tail. In some examples, the characterization circuitry 210 is instantiated by programmable circuitry executing characterization instructions and/or configured to perform operations such as those represented by the flowchart(s) of FIG. 3.

In some examples, the apparatus includes means for retrieving data. For example, the means for defining may be implemented by the characterization circuitry 210. In some examples, the characterization circuitry 210 may be instantiated by programmable circuitry such as the example programmable circuitry 512 of FIG. 5. For instance, the characterization circuitry 210 may be instantiated by the example microprocessor 600 of FIG. 6 executing machine executable instructions such as those implemented by at least blocks 312 of FIG. 3. In some examples, the characterization circuitry 210 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the characterization circuitry 210 may be instantiated by any other combination of hardware, software, and/or firmware. For example, the characterization circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The prediction circuitry 112 includes ground truth circuitry 212, which builds an expert selection ground truth indicator denoting the relevant expert to be predicted for each sample. In some examples, the ground truth circuitry 212 is instantiated by programmable circuitry executing ground truth instructions and/or configured to perform operations such as those represented by the flowchart(s) of FIG. 3.

In some examples, the apparatus includes means for retrieving data. For example, the means for building may be implemented by the ground truth circuitry 212. In some examples, the ground truth circuitry 212 may be instantiated by programmable circuitry such as the example programmable circuitry 512 of FIG. 5. For instance, the ground truth circuitry 212 may be instantiated by the example microprocessor 600 of FIG. 6 executing machine executable instructions such as those implemented by at least blocks 318 of FIG. 3. In some examples, the ground truth circuitry 212 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the ground truth circuitry 212 may be instantiated by any other combination of hardware, software, and/or firmware. For example, the ground truth circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Further, the prediction circuitry 112 includes gating loss circuitry 214, which calculates and/or determines a gating loss using the expert selection ground truth indicator. In some examples, the gating loss circuitry 214 is instantiated by programmable circuitry executing gating loss instructions and/or configured to perform operations such as those represented by the flowchart(s) of FIG. 3.

In some examples, the apparatus includes means for retrieving data. For example, the means for calculating may be implemented by the gating loss circuitry 214. In some examples, the gating loss circuitry 214 may be instantiated by programmable circuitry such as the example programmable circuitry 512 of FIG. 5. For instance, the gating loss circuitry 214 may be instantiated by the example microprocessor 600 of FIG. 6 executing machine executable instructions such as those implemented by at least blocks 320 of FIG. 3. In some examples, the gating loss circuitry 214 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the gating loss circuitry 214 may be instantiated by any other combination of hardware, software, and/or firmware. For example, the gating loss circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Further, the prediction circuitry 112 includes summation circuitry 216, which sums the task loss and the gating loss to train the MLP gate. In some examples, the summation circuitry 216 is instantiated by programmable circuitry executing summation instructions and/or configured to perform operations such as those represented by the flowchart(s) of FIG. 3.

In some examples, the apparatus includes means for retrieving data. For example, the means for calculating may be implemented by the summation circuitry 216. In some examples, the summation circuitry 216 may be instantiated by programmable circuitry such as the example programmable circuitry 512 of FIG. 5. For instance, the summation circuitry 216 may be instantiated by the example microprocessor 600 of FIG. 6 executing machine executable instructions such as those implemented by at least blocks 322 of FIG. 3. In some examples, the summation circuitry 216 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the summation circuitry 216 may be instantiated by any other combination of hardware, software, and/or firmware. For example, the summation circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In addition, the prediction circuitry 112 includes weight prediction circuitry 218, which provides a weight of each expert, weighing the characterization's corresponding expert more than the other experts. In some examples, the summation circuitry 216 is instantiated by programmable circuitry executing weight predication instructions and/or configured to perform operations such as those represented by the flowchart(s) of FIG. 3.

In some examples, the apparatus includes means for retrieving data. For example, the means for weighing may be implemented by the weight prediction circuitry 218. In some examples, the weight prediction circuitry 218 may be instantiated by programmable circuitry such as the example programmable circuitry 512 of FIG. 5. For instance, the weight prediction circuitry 218 may be instantiated by the example microprocessor 600 of FIG. 6 executing machine executable instructions such as those implemented by at least blocks 314 of FIG. 3. In some examples, the weight prediction circuitry 218 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the weight prediction circuitry 218 may be instantiated by any other combination of hardware, software, and/or firmware. For example, the weight prediction circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the prediction circuitry 112 of FIG. 1 is illustrated in FIG. 2, one or more of the elements, processes, and/or devices illustrated in FIG. 2 may be combined, divided, re-arranged, omitted, eliminated, and/or implemented in any other way. Further, the data retriever circuitry 202, the expert circuitry 204, the feed circuitry 206, the task loss circuitry 208, the characterization circuitry 210, the ground truth circuitry 212, the gating loss circuitry 214, the summation circuitry 216, the weight prediction circuitry 218, and/or, more generally, the example prediction circuitry 112 of FIG. 2, may be implemented by hardware alone or by hardware in combination with software and/or firmware. Thus, for example, any of the data retriever circuitry 202, the expert circuitry 204, the feed circuitry 206, the task loss circuitry 208, the characterization circuitry 210, the ground truth circuitry 212, the gating loss circuitry 214, the summation circuitry 216, the weight prediction circuitry 218, and/or, more generally, the example prediction circuitry 112, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example prediction circuitry 112 of FIG. 2 may include one or more elements, processes, and/or devices in addition to, or instead of, those illustrated in FIG. 2, and/or may include more than one of any or all of the illustrated elements, processes and devices.

The flowchart is representative of example machine readable instructions, which may be executed by programmable circuitry to implement and/or instantiate the prediction circuitry 112 of FIG. 2 and/or representative of example operations which may be performed by programmable circuitry to implement and/or instantiate the prediction circuitry 112 of FIG. 2, is shown in FIG. 3. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 3, many other methods of implementing the example prediction circuitry may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to train machine learning models to predict categories of textual descriptions. The example machine-readable instructions and/or the example operations 300 of FIG. 3 begin at block 302, at which the data retriever circuitry 202 retrieves a batch of samples from a data set (block 302). In some examples, the data set is retrieved from a database (e.g., database 102) and/or local storage (e.g., local data storage 108). The example expert circuitry 204 calculates a loss for each sample within the batch using a first expert (e.g., a first model) (block 304), a second expert (e.g., a second model) (block 306), and a third expert (e.g., a third model) (block 308). In some examples, the first expert, the second expert, and the third expert correspond to example Equation 1, example Equation 2, and example Equation 3, respectively. The example feed circuitry 206 feeds all the predictions (e.g., category information) to train an MLP gate (block 310). For example, if the batch includes 50 samples, then the feed circuitry 206 feeds 50 predictions from the first expert to the MLP gate (e.g., model gate), 50 predictions from the second expert to the MLP gate (e.g., model gate), and 50 predictions from the third expert to the MLP gate (e.g., model gate), thus a total of 150 predictions are fed to the MLP gate (e.g., model gate).

The characterization circuitry 210 defines what threshold of samples in the data set constitutes a head, body, and tail (block 312). In some examples, a first threshold quantity represents the head, a second threshold quantity that is less than the first threshold quantity represents the body, and a third threshold quantity that is less than the second threshold quantity represents the tail. In some examples, samples within the data set that represent more than 50% of the data represent the head, while the body and tail correspond to samples representing 40% and 10% of the data, respectively. Additionally, the ground truth circuitry 212 builds an expert selection ground truth indicator denoting the relevant expert to be predicted for each sample by determining for each sample the characterization and/or typology. For example, if it is defined that samples within the data set that gather more than 50% of the data represent the head, and a particular sample belongs to the data gathering more than 50%, the sample's expert selection ground truth indicator would be the head expert. The weight prediction circuitry 218 calculates a weight of each expert while weighing the characterization's corresponding expert more than the other experts (block 314). The task loss circuitry 208 then calculates a task loss using a product category ground truth indicator (block 316). The ground truth refers to the actual nature of the problem that is the target of the machine learning model, reflected by the relevant data sets associated with the use case in question. For example, if a sample textual description is “Poland Spring” and the nature of the problem is product categorization, then the ground truth may be bottled water. In some examples, the task loss circuitry 208 calculates the task loss by using the example softmax cross-entropy loss technique in a manner consistent with example Equation 1 above, with the product ground truth indicator to verify that a combined prediction matches the product category ground-truth. In some examples, the task loss circuitry 208 uses the product categorization ground-truth, which helps the MLP gate (e.g., model gate) to produce weights that are also meaningful to perform product categorization accurately and/or with less error when compared to traditional techniques. The gating loss circuitry 214 calculates a gating loss using the expert selection ground truth indicator (block 320). In some examples, the gating loss is calculated by using the softmax cross-entropy loss (equation 1) with the expert selection ground truth indicator. The summation circuitry 216 sums the task loss and the gating loss multiplied by a multiplication factor which corresponds to equation 4 (block 322). The summation of the task loss and the gating loss is used to train the MLP gate (e.g., model gate) to derive the weights for each expert. Once the weights are predicted the process is finished, and the machine learning model is now trained to operate with less bias to the head. In some examples, the summation circuitry 216 ends and/or otherwise awaits a trigger to repeat (e.g., a manual trigger, a time-based trigger, an iteration count trigger, etc.). The model is now ready for a production environment to accurately and efficiently predict product categorization.

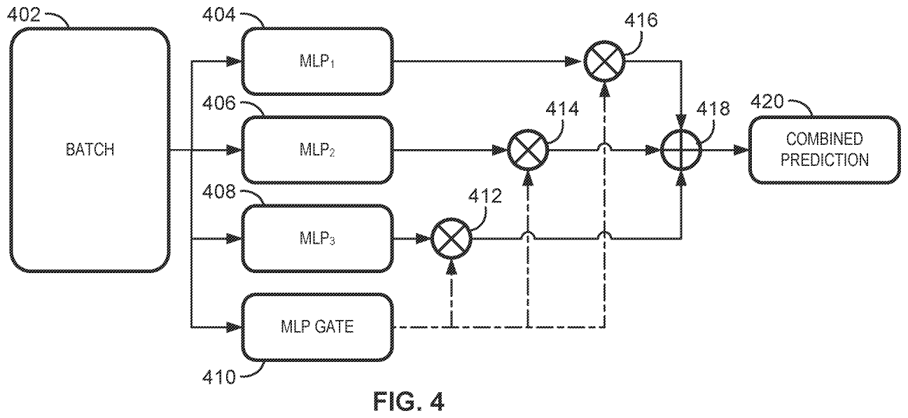

FIG. 4 is a schematic diagram of an example implementation of the prediction circuitry 112 of FIG. 2. In this example, a batch 402 is fed to an MLP1 404, MLP2 406, and MLP3 408. The batch 402 may include number of samples (e.g., 25 samples, 50 samples, 100 samples, etc.). In some examples, MLP1 404, MLP2 406, and MLP3 408 correspond to the first expert, the second expert and the third expert. Simultaneously, the batch 402 is fed to an MLP gate 410 that had been trained using a task loss using a product category indicator that verifies the correct product category is predicted and a gating loss that depends on the expert selection ground truth indicator to determine which prediction of MLP1 404, MLP2 406, or MLP3 408 to weigh more heavily. Stated differently, the MLP gate 410 is trained using the gating loss to understand that a sample is from the head, body and tail (e.g., the sample characteristic and/or typology) and depending on this decides to give, respectively, more importance to MLP1 404, MLP2 406, or MLP3 408 (e.g., the head expert, the body expert, and the tail expert) to predict the category of the particular sample. For example, when prediction circuitry 112 is fed a head sample, the MLP gate 410 is fed data that includes that the sample is from the head and the MLP gate 410 calculates an output, in the form of three weights 412, 414, 416 that gives importance to the MLP1 404 (e.g., head expert) by allocating the highest weight to MLP1 404, to predict that sample. However, this does not mean the prediction circuitry 112 does not use the other experts (e.g., the body expert and the tail expert). Ideally, the prediction circuitry 112 would not contribute the other experts (e.g., the body expert and the tail expert) by weighing the other experts with a value of zero at the output of the MLP gate 410. However, more typically the prediction circuitry 112 includes the other experts (e.g., the body expert and the tail expert) but with smaller weight values than the weight value for the head expert. The three weights 412, 414, 416 are then combined 418 and the prediction circuitry 112 produces a combined prediction 420. In some examples, the combined prediction 420 is a product categorization for the particular sample. For example, if the particular sample within the batch 402 is a textual description of a nail clipper, then the combined prediction 420 may be beauty products.

FIG. 5 is a block diagram of an example programmable circuitry platform 500 structured to execute and/or instantiate the example machine-readable instructions and/or the example operations of FIG. 3 to implement the prediction circuitry of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements data retriever circuitry 202, the expert circuitry 204, the feed circuitry 206, the task loss circuitry 208, the characterization circuitry 210, the ground truth circuitry 212, the gating loss circuitry 214, the summation circuitry 216, and the weight prediction circuitry 218.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIG. 3, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowchart of FIG. 3 to effectively instantiate the circuitry of FIG. 2 as logic circuits to perform operations corresponding to those machine readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIG. 3.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart of FIG. 3 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart of FIG. 3. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 3. As such, the FPGA circuitry 700 may be configured and/or structured to effectively instantiate some or all of the operations/functions corresponding to the machine readable instructions of the flowchart of FIG. 3 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIG. 3 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIGS. 3 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIG. 3 to perform first operation(s)/function(s), the FPGA circuitry 700 of FIG. 7 may be configured and/or structured to perform second operation(s)/function(s) corresponding to a second portion of the machine readable instructions represented by the flowcharts of FIG. 3, and/or an ASIC may be configured and/or structured to perform third operation(s)/function(s) corresponding to a third portion of the machine readable instructions represented by the flowcharts of FIG. 3.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

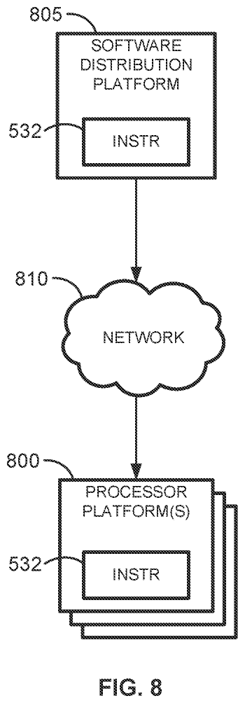

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIG. 3, may be downloaded to the example programmable circuitry platform 500, which is to execute the machine readable instructions 532 to implement the prediction circuitry. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that increase the accuracy of machine learning model and reduce energy consumption by removing the need for human resources in circumstances where models are trained. Additionally, the disclosed examples reduce the need for re-training models to increase coverage because the examples disclosed herein do not reduce head bias by mitigating the influence of the head expert. Disclosed systems, apparatus, articles of manufacture, and methods improve the efficiency of using a computing device by evaluating each sample individually and reducing long-tail problems by learning several expert and dynamically combining these experts for each sample, so that a robust prediction is provided. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to reduce long-tail categorization bias are disclosed herein. Further examples and combinations thereof include the following:

Example 1 includes an apparatus to train machine learning models to reduce categorization bias, the apparatus comprising interface circuitry, machine readable instructions, and programmable circuitry to at least one of instantiate or execute the machine readable instructions to calculate category information corresponding to samples based on a plurality of models, calculate task loss values associated with respective ones of the samples and respective ones of the plurality of models based on product category information, calculate gating loss values for a model gate based on category frequency information, and train the model gate based on a sum of the task loss and the gating loss, the training to derive weights corresponding to respective ones of the plurality of models.

Example 2 includes the apparatus of example 1, wherein a first one of the plurality of models is a softmax cross-entropy loss function.

Example 3 includes the apparatus of example 1, wherein a second one of the plurality of models is a balanced softmax loss function.

Example 4 includes the apparatus of example 1, wherein a third one of the plurality of models is an inverted softmax loss function.

Example 5 includes the apparatus of example 1, wherein a first category frequency corresponds to a first threshold quantity of the samples and a second category frequency corresponds to a second threshold quantity of the samples, the first threshold quantity greater than the second threshold quantity.

Example 6 includes the apparatus of example 5, wherein a third category frequency corresponds to a third threshold quantity of the samples, the second threshold quantity of the samples greater than the third threshold quantity of the samples.

Example 7 includes the apparatus of example 1, wherein the gating loss is multiplied by a multiplication factor to modulate a contribution of the gating loss.

Example 8 includes the apparatus of example 1, wherein the task loss values are multiplied by a multiplication factor to modulate contributions of the task loss values.

Example 9 includes an apparatus to reduce categorization bias, the apparatus comprising interface circuitry to retrieve data, computer readable instructions, and programmable circuitry to instantiate expert circuitry to evaluate category information corresponding to data points based on a plurality of models, task loss circuitry to determine task loss values associated with respective ones of the data points and respective ones of the plurality of models based on product category information, gating loss circuitry determine gating loss values for a model gate based on category frequency information, and summation circuitry to train the model gate based on a sum of the task loss and the gating loss, the training to derive weights corresponding to respective ones of the plurality of models.

Example 10 includes the apparatus of example 9, wherein a first one of the plurality of models is a softmax cross-entropy loss function.

Example 11 includes the apparatus of example 9, wherein a second one of the plurality of models is a balanced softmax loss function.

Example 12 includes the apparatus of example 9, wherein a third one of the plurality of models is an inverted softmax loss function.

Example 13 includes the apparatus of example 9, wherein a first category frequency corresponds to a first threshold quantity of the data points and a second category frequency corresponds to a second threshold quantity of the data points, the first threshold quantity greater than the second threshold quantity.

Example 14 includes the apparatus of example 13, wherein a third category frequency corresponds to a third threshold quantity of the data points, the second threshold quantity of the data points greater than the third threshold quantity of the data points.

Example 15 includes the apparatus of example 9, wherein the gating loss is multiplied by a multiplication factor to modulate a contribution of the gating loss.

Example 16 includes the apparatus of example 9, wherein the task loss values are multiplied by a multiplication factor to modulate contributions of the task loss values.

Example 17 includes a method of reducing categorization bias in machine learning models, the method comprising calculating, by executing instructions with at least one processor, category information corresponding to samples based on a plurality of models, calculating, by executing instructions with at least one processor, task loss values associated with respective ones of the samples and respective ones of the plurality of models based on product category information, calculating, by executing instructions with at least one processor, gating loss values for a model gate based on category frequency information, and training, by executing instructions with at least one processor, the model gate based on a sum of the task loss and the gating loss, the training to derive weights corresponding to respective ones of the plurality of models.

Example 18 includes the method of example 17, wherein a first one of the plurality of models is a softmax cross-entropy loss function.

Example 19 includes the method of example 17, wherein a second one of the plurality of models is a balanced softmax loss function.

Example 20 includes the method of example 17, wherein a third one of the plurality of models is an inverted softmax loss function.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to train machine learning models to reduce categorization bias, the apparatus comprising:
interface circuitry;
machine readable instructions; and
programmable circuitry to at least one of instantiate or execute the machine readable instructions to:
calculate category information corresponding to samples based on a plurality of models;
calculate task loss values associated with respective ones of the samples and respective ones of the plurality of models based on product category information;
calculate gating loss values for a model gate based on category frequency information; and
train the model gate based on a sum of the task loss and the gating loss, the training to derive weights corresponding to respective ones of the plurality of models.

2. The apparatus of claim 1, wherein a first one of the plurality of models is a softmax cross-entropy loss function.

3. The apparatus of claim 1, wherein a second one of the plurality of models is a balanced softmax loss function.

4. The apparatus of claim 1, wherein a third one of the plurality of models is an inverted softmax loss function.

5. The apparatus of claim 1, wherein a first category frequency corresponds to a first threshold quantity of the samples and a second category frequency corresponds to a second threshold quantity of the samples, the first threshold quantity greater than the second threshold quantity.

6. The apparatus of claim 5, wherein a third category frequency corresponds to a third threshold quantity of the samples, the second threshold quantity of the samples greater than the third threshold quantity of the samples.

7. The apparatus of claim 1, wherein the gating loss is multiplied by a multiplication factor to modulate a contribution of the gating loss.

8. The apparatus of claim 1, wherein the task loss values are multiplied by a multiplication factor to modulate contributions of the task loss values.

9. An apparatus to reduce categorization bias, the apparatus comprising:
interface circuitry to retrieve data;
computer readable instructions; and
programmable circuitry to instantiate:
expert circuitry to evaluate category information corresponding to data points based on a plurality of models;
task loss circuitry to determine task loss values associated with respective ones of the data points and respective ones of the plurality of models based on product category information;
gating loss circuitry determine gating loss values for a model gate based on category frequency information; and
summation circuitry to train the model gate based on a sum of the task loss and the gating loss, the training to derive weights corresponding to respective ones of the plurality of models.

10. The apparatus of claim 9, wherein a first one of the plurality of models is a softmax cross-entropy loss function.

11. The apparatus of claim 9, wherein a second one of the plurality of models is a balanced softmax loss function.

12. The apparatus of claim 9, wherein a third one of the plurality of models is an inverted softmax loss function.

13. The apparatus of claim 9, wherein a first category frequency corresponds to a first threshold quantity of the data points and a second category frequency corresponds to a second threshold quantity of the data points, the first threshold quantity greater than the second threshold quantity.

14. The apparatus of claim 13, wherein a third category frequency corresponds to a third threshold quantity of the data points, the second threshold quantity of the data points greater than the third threshold quantity of the data points.

15. The apparatus of claim 9, wherein the gating loss is multiplied by a multiplication factor to modulate a contribution of the gating loss.

16. The apparatus of claim 9, wherein the task loss values are multiplied by a multiplication factor to modulate contributions of the task loss values.

17. A method of reducing categorization bias in machine learning models, the method comprising:
calculating, by executing instructions with at least one processor, category information corresponding to samples based on a plurality of models;
calculating, by executing instructions with at least one processor, task loss values associated with respective ones of the samples and respective ones of the plurality of models based on product category information;
calculating, by executing instructions with at least one processor, gating loss values for a model gate based on category frequency information; and
training, by executing instructions with at least one processor, the model gate based on a sum of the task loss and the gating loss, the training to derive weights corresponding to respective ones of the plurality of models.

18. The method of claim 17, wherein a first one of the plurality of models is a softmax cross-entropy loss function.

19. The method of claim 17, wherein a second one of the plurality of models is a balanced softmax loss function.

20. The method of claim 17, wherein a third one of the plurality of models is an inverted softmax loss function.
